(19) United States
(12) Patent Application Publication
(10) Pub. No.: US 2026/0201824 A1
(43) Pub. Date: Jul. 16, 2026

(54) CONTROL DEVICE, CONTROL METHOD, AND ENGINE SYSTEM

(71) Applicant: KOMATSU LTD., Tokyo (JP)

(72) Inventors: Mitsuyoshi Kimura, Tokyo (JP); Go Aikawa, Tokyo (JP); Akikazu Miyahara, Tokyo (JP); Tatsuya Yoshida, Tokyo (JP)

(73) Assignee: KOMATSU LTD., Tokyo (JP)

(21) Appl. No.: 19/135,138

(22) PCT Filed: Nov. 27, 2023
(86) PCT No.: PCT/JP2023/042367

§ 371 Date: Jun. 3, 2025

(30) Foreign Application Priority Data
Jan. 16, 2023 (JP) 2023-004425

(51) Int. Cl. F01N 9/00; B01D 46/44; B01D 46/46; B01D 46/82; B01D 46/84; B01D 53/94; F01N 3/023; F01N 3/10

(52) U.S. Cl. CPC F01N 9/002; B01D 46/442; B01D 46/46; B01D 46/82; B01D 46/84; B01D 53/944; B01D 53/9477; B01D 53/9495; F01N 3/023; F01N 3/106; B01D 2257/404; B01D 2258/012; F01N 2900/08; F01N 2900/1611

(57) ABSTRACT

A control device is a control device of an engine system including an engine, an oxidation catalyst provided in an exhaust passage of the engine, and a filter configured to collect soot within the exhaust passage, the soot being contained in exhaust gas of the engine, the control device including: an ash accumulation amount estimation unit configured to estimate an ash amount accumulated in the filter; and a regeneration control unit configured to control regeneration of the filter when the ash amount is equal to or less than a predetermined threshold value so that a predetermined amount of the soot remains in the filter, and control regeneration of the filter when the ash amount is greater than the threshold value so that the remaining amount of the soot in the filter is less than the predetermined amount.

### TECHNICAL FIELD

The present disclosure relates to a control device, a control method, and an engine system.

This application claims priority based on Japanese Patent Application No. 2023-004425 filed in Japan on Jan. 16, 2023, the contents of which are incorporated herein by reference.

### BACKGROUND ART

As described in PTL 1, it has been confirmed that, for a diesel particulate filter (hereinafter, referred to as a “DPF”) that collects particulate matter (PM) contained in exhaust gas of a diesel engine, the soot collection efficiency is improved when a certain amount of soot is accumulated (Paragraph [0009] of PTL 1). Thus, immediately after regeneration processing for burning and removing soot accumulated in the DPF (hereinafter, referred to as “regeneration”), the soot collection efficiency may be degraded. In view of this, in the exhaust purification device described in PTL 1, regeneration is terminated while leaving an appropriate amount of soot. With this, degradation of the soot collection efficiency immediately after regeneration is suppressed.

Further, NPTL 1 and NPTL 2 describe the following technical matters. NPTL 1 describes that, for example, the collection efficiency of the DPF is improved when a soot layer is formed on a partition wall surface of the DPF. Further, NPTL 2 describes that, for example, an ash layer formed on the DPF inhibits penetration of soot beyond the wall.

Note that particulate matter (hereinafter, referred to as “PM”) contained in exhaust gas of a diesel engine includes soot, ash, and the like. Soot is carbon discharged from an engine, and is accumulated in a DPF installed downstream of the engine. The soot accumulated in the DPF reacts with nitrogen dioxide or oxygen during regeneration, and is removed from the DPF. On the other hand, ash is an ash content contained in engine oil, and is accumulated in the DPF as a trace amount of oil combusts in a combustion chamber. Ash is not removed even through regeneration, and remains inside the DPF. Further, accumulation of ash continues as the engine operates.

### Citation List

### Patent Literature

PTL 1: JP 2005-307746 A

### Non-Patent Literature

NPTL 1: Koji Tsuneyoshi, Osamu Takagi, and Kazuhiro Yamamoto, “Effect of Surface Roughness on Initial PM Filtration Efficiency of DPF”, Transactions of the Japan Society of Mechanical Engineers, Series B, The Japan Society of Mechanical Engineers, Vol. 76, No. 767, Jul. 25, 2010, pp. 100-107 (pp. 1110-1117)
NPTL 2: Akira Usui, Toru Uenishi, Takao Fukuma, and Hitoshi Kusaka, “Evaluation of Diesel Particulate Filter with Ash Deposit”, Transactions of the Society of Automotive Engineers of Japan, Inc., Society of Automotive Engineers of Japan, Vol. 49, No. 4, July 2018, pp. 690-695

### SUMMARY OF INVENTION

### Technical Problem

As described above, in the exhaust purification device described in PTL 1, regeneration is terminated while leaving a predetermined amount of soot. However, in a case in which a predetermined amount of soot is left, when the remaining amount is increased, there is possibility that, depending on an operating condition or the like, the time until subsequent regeneration is required is shortened. In this regard, it is desired to leave as little soot as possible when regeneration process is terminated.

The present disclosure has been made in view of the above-mentioned circumstances, and has an object to provide a control device, a control method, and an engine system that can reduce an amount of soot remaining when regeneration is terminated.

### Solution to Problem

An aspect of the present disclosure is a control device of an engine system including an engine, an oxidation catalyst provided in an exhaust passage of the engine, and a filter configured to collect soot within the exhaust passage, the soot being contained in exhaust gas of the engine, the control device including: an ash accumulation amount estimation unit configured to estimate an ash amount accumulated in the filter; and a regeneration control unit configured to control regeneration of the filter when the ash amount is equal to or less than a predetermined threshold value so that a predetermined amount of the soot remains in the filter, and control regeneration of the filter when the ash amount is greater than the threshold value so that the remaining amount of the soot in the filter is less than the predetermined amount.

An aspect of the present disclosure is a control method of an engine system including an engine, an oxidation catalyst provided in an exhaust passage of the engine, and a filter that collects soot within the exhaust passage, the soot being contained in exhaust gas of the engine, the control method including: estimating an ash amount accumulated in the filter; and controlling regeneration of the filter when the ash amount is equal to or less than a predetermined threshold value so that a predetermined amount of the soot remains in the filter and controlling regeneration of the filter when the ash amount is greater than the threshold value so that the remaining amount of the soot in the filter is less than the predetermined amount.

An aspect of the present disclosure is an engine system including an engine, an oxidation catalyst provided in an exhaust passage of the engine, a filter configured to collect soot within the exhaust passage, the soot being contained in exhaust gas of the engine, and a control device configured to control regeneration of the filter. The control device includes: an ash accumulation amount estimation unit configured to estimate an ash amount accumulated in the filter; and a regeneration control unit configured to control regeneration of the filter when the ash amount is equal to or less than a predetermined threshold value so that a predetermined amount of the soot remains in the filter, and controls regeneration of the filter when the ash amount is greater than the threshold value so that the remaining amount of the soot in the filter is less than the predetermined amount.

### Advantageous Effects of Invention

According to the control device, the control method and the engine system of the present disclosure, an amount of soot remaining when regeneration is terminated can be reduced.

### BRIEF DESCRIPTION OF DRAWINGS

FIG. 1 is an overview configuration diagram of an engine system according to a first embodiment to a third embodiment of the present disclosure.

FIG. 2 is a block diagram illustrating a configuration example of an ECU according to the first embodiment to the third embodiment of the present disclosure.

FIG. 3 is a flowchart illustrating an operation example of the ECU according to the first embodiment of the present disclosure.

FIG. 4 is a timing chart schematically illustrating an operation example of the first embodiment of the present disclosure.

FIG. 5 is a flowchart illustrating an operation example of the ECU according to the second embodiment of the present disclosure.

FIG. 6 is a timing chart schematically illustrating an operation example of the second embodiment of the present disclosure.

FIG. 7 is a flowchart illustrating an operation example of the ECU according to the third embodiment of the present disclosure.

FIG. 8 is a timing chart schematically illustrating an operation example of the third embodiment of the present disclosure.

### DESCRIPTION OF EMBODIMENTS

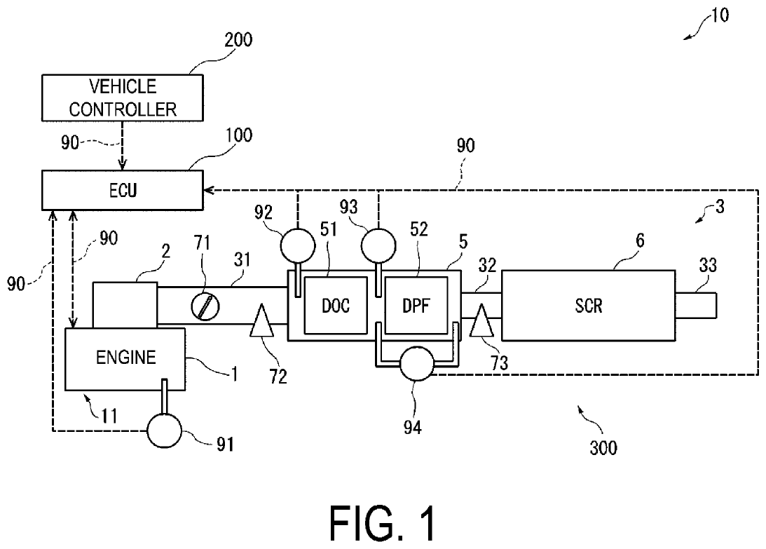

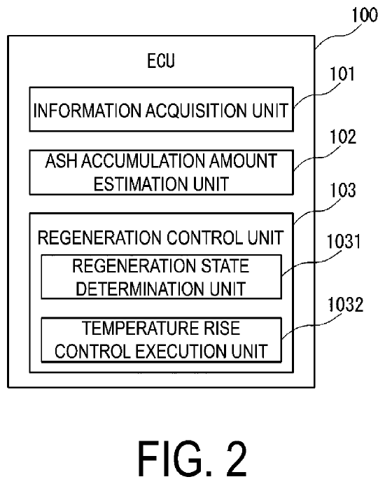

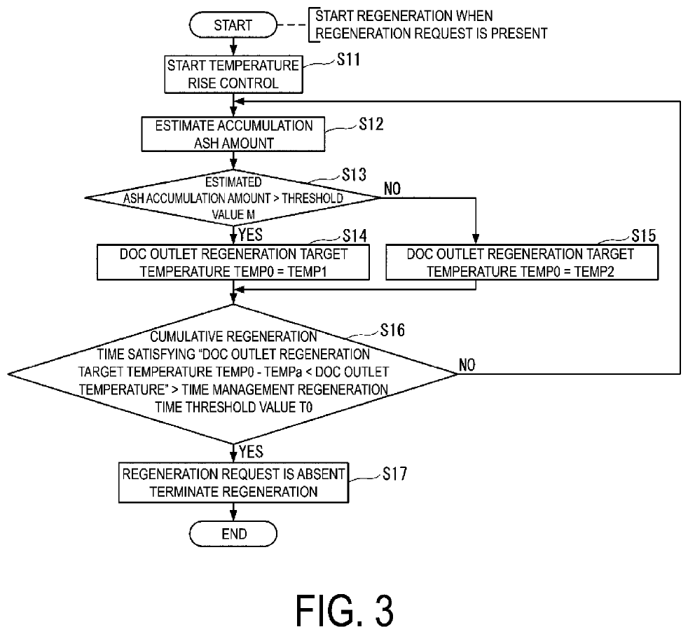

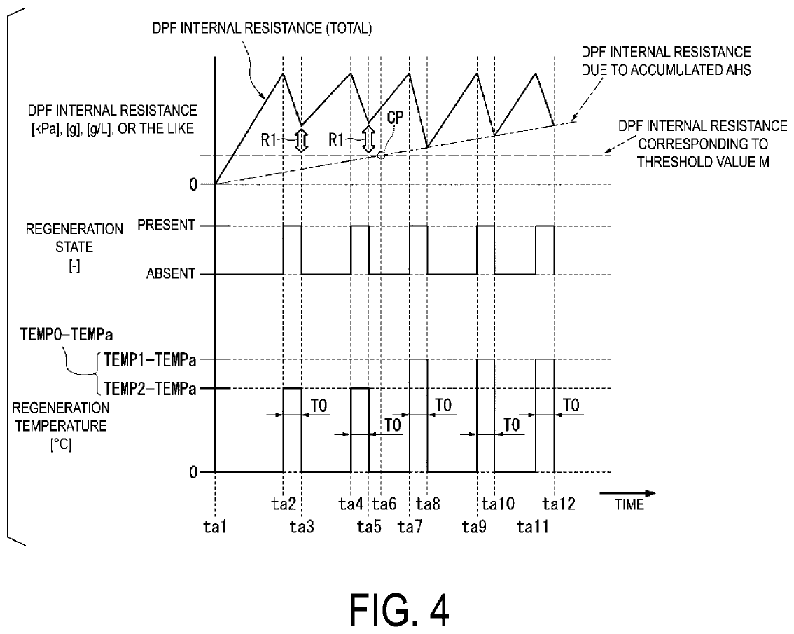

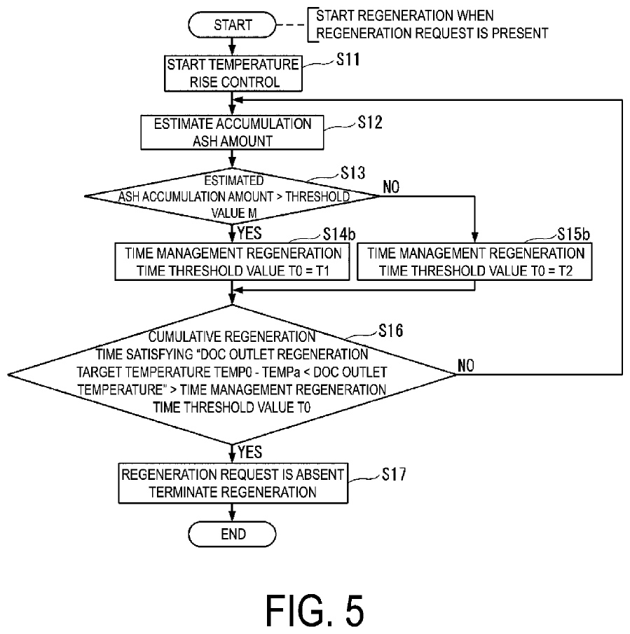

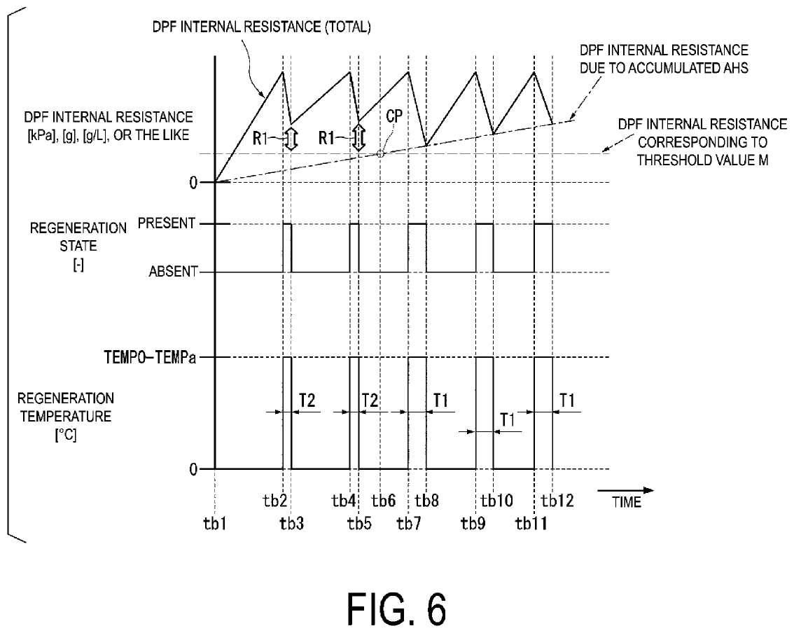

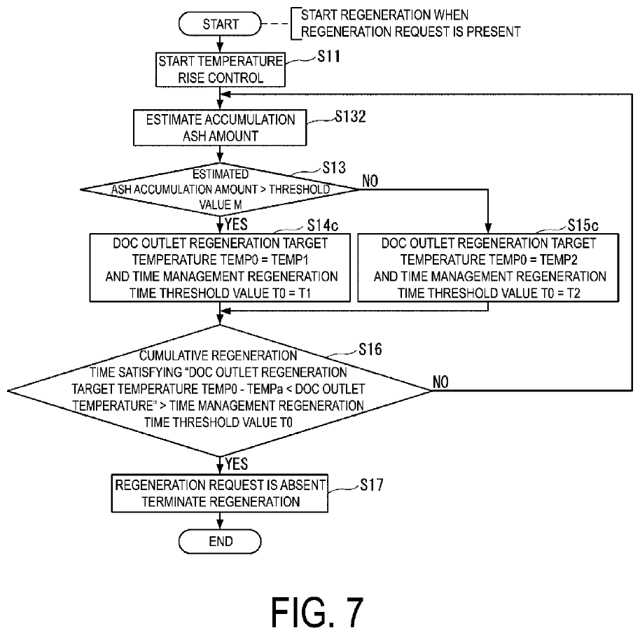

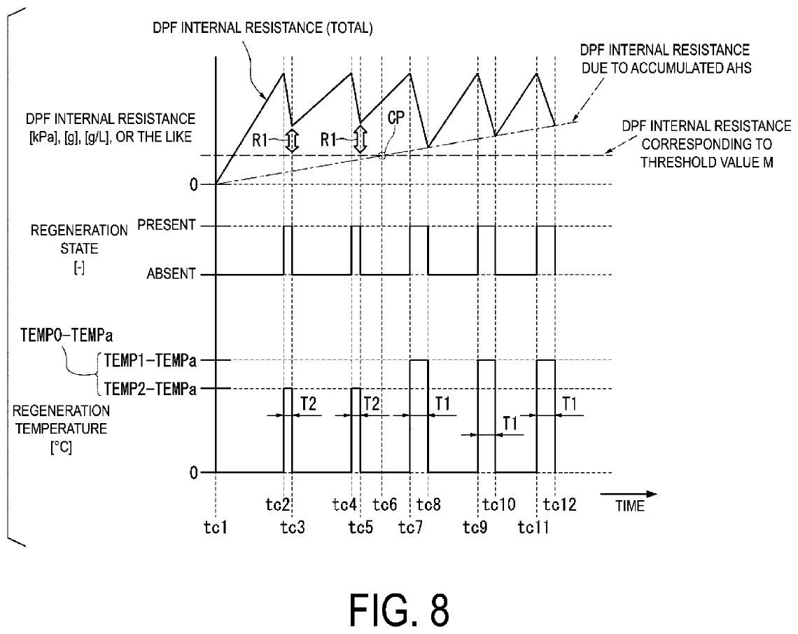

Hereinafter, with reference to the drawings, embodiments of the present disclosure are described. FIG. 1 is an overview configuration diagram of an engine system according to a first embodiment to a third embodiment of the present disclosure. FIG. 2 is a block diagram illustrating a configuration example of an ECU according to the first embodiment to the third embodiment of the present disclosure. FIG. 3 is a flowchart illustrating an operation example of the ECU according to the first embodiment of the present disclosure. FIG. 4 is a timing chart schematically illustrating an operation example of the first embodiment of the present disclosure. FIG. 5 is a flowchart illustrating an operation example of the ECU according to the second embodiment of the present disclosure. FIG. 6 is a timing chart schematically illustrating an operation example of the second embodiment of the present disclosure. FIG. 7 is a flowchart illustrating an operation example of the ECU according to the third embodiment of the present disclosure. FIG. 8 is a timing chart schematically illustrating an operation example of the third embodiment of the present disclosure. Note that the same or corresponding configurations in the respective drawings are denoted with the same reference symbols, and the description thereof is omitted as appropriate.

### First Embodiment

### Overview Configuration of Engine System

FIG. 1 schematically illustrates an overview configuration of an engine system 10 according to the first embodiment to the third embodiment. The engine system 10 is a system including a diesel engine 1 (hereinafter, also referred to as an engine), a control system of the engine 1, and an exhaust purification device. The engine 1 is mounted on a work machine that is used for a task such as excavation or transports earth and sand at a construction site such as a mine and a road. In this case, the work machine includes a construction machine such as a hydraulic excavator, a wheel loader, a bulldozer, a motor grader, and a crane and a transport vehicle such as a dump truck and a forklift. However, the engine system 10 of the present embodiment is not limited to be mounted on a work machine, and may be used in various vehicles and machines.

The engine system 10 illustrated in FIG. 1 includes the engine 1, a turbocharger 2, an engine control unit (ECU) 100, a vehicle controller 200, and an exhaust purification device 300. The engine 1 is, for example, a multi-cylinder diesel engine, and is provided with an engine speed sensor 91 that detects an engine rotation speed, a fuel injection device 11 (omitted in illustration) that injects a fuel to the engine 1, and the like. Detection data of the engine speed sensor 91 is output to the ECU 100 via a signal line 90. Further, the ECU 100 controls a fuel injection amount injected by the fuel injection device 11 or the like according to a signal indicating an accelerator opening degree, which is transmitted from the vehicle controller 200, or the like. For example, the signal line 90 includes a communication line for a controller area network (CAN), a signal line for each sensor, and the like. Further, the turbocharger 2 compresses air supplied to the engine 1 by rotating a turbine by exhaust gas of the engine 1.

### Exhaust Purification Device

The exhaust purification device 300 is a device that executes post-processing such as collection and reduction of a residual substance such as PM and nitrogen oxides (NOx) in the exhaust gas of the engine 1, and is controlled by the ECU 100. The exhaust purification device 300 includes an exhaust throttle valve 71, a fuel injection device 72, a DPF device 5, a urea water injection device 73, and a selective catalyst reduction (hereinafter, referred to as “SCR”) device 6 in the stated order from the upstream in a flow direction of the exhaust gas discharged from the engine 1. The DPF device 5 includes a diesel oxidation catalyst (hereinafter, referred to as “DOC”) 51 and a DPF 52. The DPF device 5, the SCR device 6, and the like are provided inside an exhaust passage 3 through which the exhaust gas from the engine 1 flows. The exhaust passage 3 includes an inlet pipe 31 that guides the exhaust gas from the turbocharger 2 connected to the engine 1 to the DPF device 5, an outlet pipe 32 that connects the DPF device 5 and the SCR device 6 to each other, and an outlet pipe 33 that is connected to an outlet of the SCR device 6. Further, in the outlet pipe 32, there is provided a mechanism that diffuses urea water supplied from the urea water injection device 73.

### Exhaust Throttle Valve

The exhaust throttle valve 71 is configured by a butterfly valve or the like arranged in the inlet pipe 31. The valve opening degree of the exhaust throttle valve 71 is controlled by the ECU 100, and the temperature of the exhaust gas is controlled by adjusting the valve opening degree. When the valve opening degree is reduced, the exhaust gas is compressed upstream of the exhaust throttle valve 71, and the pressure and the temperature of the exhaust gas flowing through the exhaust passage 3 are increased.

### DPF Device

As described above, the DPF device 5 includes the DOC 51 and the DPF 52, and regeneration of the DPF 52 is carried out by the action of the DOC 51. The DPF device 5 collects PM in the DPF 52. Soot in PM collected downstream is oxidized into carbon dioxide by nitrogen dioxide converted by the DOC 51 provided upstream of the DPF 52, for example. In this manner, the soot is removed.

The DOC 51 includes a case, and the diesel oxidation catalyst is stored inside the case. The DOC 51 is a catalyst that oxidizes and heats a fuel (hereinafter referred to as a “dosing fuel”) which is supplied as required into the exhaust gas (supply of the dosing fuel is referred to as “fuel dosing”). With this, the exhaust gas temperature is increased to a predetermined high temperature range. For example, the DPF 52 is regenerated as described above by using the exhaust gas with the increased temperature, and the outlet pipe 32 and the like are regenerated by decomposing and removing a urea deposit accumulated in the outlet pipe 32 and the like as described later. The dosing fuel is, for example, a diesel fuel, which is the same as the engine fuel. When the dosing fuel is supplied to an engine cylinder, the dosing fuel is supplied through post-injection by the fuel injection device 11 for engine cylinder injection. Further, in the present embodiment, the fuel injection device 72 for fuel dosing, which is provided to the inlet pipe 31, supplies the fuel into the exhaust gas, and the fuel flows into the DOC 51 together with the exhaust gas.

### Urea Water Injection Device

The urea water injection device 73 is a device that adds a urea aqueous solution as a reducing agent aqueous solution into the exhaust gas. The urea water injection device 73 is an injection nozzle that is attached to the outlet pipe 32 of the DPF device 5 and injects the urea aqueous solution into the outlet pipe 32. A pump unit (omitted in illustration) is connected to the urea water injection device 73, and supplies the urea aqueous solution from a urea water tank (omitted in illustration) in which the urea aqueous solution is stored to the injection nozzle. The ECU 100 controls the urea water injection device 73 and the pump unit, and injects the urea aqueous solution from the urea water injection device 73 into the outlet pipe 32. The urea aqueous solution injected into the outlet pipe 32 is hydrolyzed by the heat of the exhaust gas, and is converted into ammonia.

### SCR Device

The SCR device 6 is a device that reduces and purifies nitrogen oxides in the exhaust gas by using ammonia, which is obtained through the hydrolysis of the urea aqueous solution, as a reducing agent. Ammonia is supplied as a reducing agent to the SCR device 6 together with the exhaust gas. Note that an ammonia oxidation catalyst may be provided downstream of the SCR device 6. The ammonia oxidation catalyst oxidizes and neutralizes ammonia that is unused in the SCR device 6, and thus the emission of the exhaust gas is reduced. When the urea aqueous solution is injected from the urea water injection device 73, urea may crystallize and precipitate inside the outlet pipe 32. Thus, it is necessary to execute regeneration processing for decomposing a precipitate (urea deposit) inside the outlet pipe 32 by setting the exhaust gas temperature to a high temperature. Note that, in the embodiment of the present disclosure, regeneration refers to both regeneration of the DPF device 5 described above and regeneration involving decomposition of a urea deposit inside the outlet pipe 32.

### Sensor

The exhaust purification device 300 is provided with various sensors that detect conditions of the diesel engine 1 and the exhaust purification device 300. In other words, the DPF device 5 is provided with an inlet temperature sensor 92 that measures the inlet temperature of the DOC 51, an outlet temperature sensor 93 that measures the outlet temperature of the DOC 51, and a differential pressure sensor 94 that measures the differential pressure upstream and downstream of the DPF 52. Note that, for example, in addition to the sensors illustrated in FIG. 1, one or a plurality of NOx sensors that detect the concentration of nitrogen oxides contained in the exhaust gas, an outlet temperature sensor that measures an outlet temperature of the DPF 52, an SCR outlet temperature sensor that measures an outlet temperature of the SCR device 6, and the like are arranged. The outlet signal of each of the sensors is transmitted to the ECU 100 via the signal line 90. Note that the output of the differential pressure sensor 94 is monitored as a value indicating an internal resistance value of the DPF 52. Further, the outlet temperature of the DOC 51 corresponds to the inlet temperature of the DPF 52 and the regeneration temperature of the DPF 52.

### Vehicle Controller

For example, the vehicle controller 200 controls each of the units of the work machine on which the engine 1 is mounted, by inputting a signal indicating an operation state (an on state, an off state, an operation amount, and the like) of each operation device (omitted in illustration), and transmitting and receiving predetermined data with another controller such as the ECU 100. In the present embodiment, the vehicle controller 200 transmits data indicating an accelerator opening degree to the ECU 100, for example. Note that, for example, the operation device includes an accelerator, a brake, steering, a shift lever, a work implement lever, and the like. Further, an accelerator is a device that operates the speed (rotation speed) of the engine 1 (or an acceleration degree thereof), and is in a form such as an accelerator pedal and accelerator lever. In the present embodiment, an operation amount of the accelerator is referred to as an “accelerator opening degree”.

### ECU

Next, a configuration of the ECU 100 is described. The ECU 100 may be configured by using a computer such as a microcomputer, and peripheral circuits and peripheral devices, and includes the respective units illustrated in FIG. 2 as a functional configuration configured by a combination of hardware such as a computer and software such as a program executed by the computer, or the like. In other words, as illustrated in FIG. 2, the ECU 100 includes an information acquisition unit 101, an ash accumulation amount estimation unit 102, and a regeneration control unit 103. Note that FIG. 2 only illustrates a part of the functional configuration of the ECU 100, which mainly relates to regeneration of the exhaust purification device 300, and other parts relating to control of the fuel injection device 11 and the like are omitted in illustration. Further, the ECU 100 is a configuration example of the control device of the present disclosure.

### Information Acquisition Unit

The information acquisition unit 101 repeatedly acquires measurement data from each of the sensors such as the engine speed sensor 91, the inlet temperature sensor 92, the outlet temperature sensor 93, and the differential pressure sensor 94 at a predetermined cycle, and repeatedly acquires data indicating the accelerator opening degree and the like from the vehicle controller 200 at a predetermined cycle.

### Ash Accumulation Amount Estimation Unit

The ash accumulation amount estimation unit 102 estimates an ash amount accumulated in the DPF 52. The ash accumulation amount estimation unit 102 estimates the ash amount accumulated in the DPF 52, based on a fuel injection amount injected by the fuel injection device 11, for example. As described above, ash is an ash content remaining after a trace amount of engine oil in a combustion chamber of the engine 1 combusts, the ash amount accumulated in the DPF 52 is correlated to a fuel injection amount from the fuel injection device 11, and an ash amount can be estimated based on
a fuel injection amount. The ash accumulation amount estimation unit 102 calculates a cumulative value of a fuel injection amount, based on the accelerator opening degree, the engine speed, and the like that are acquired from the vehicle controller 200, and estimates the ash amount accumulated in the DPF 52, based on the cumulative value of the fuel injection amount. However, the ash accumulation amount estimation unit 102 may estimate the ash amount accumulated in the DPF 52, not only based on the fuel injection amount but also based on an operation time of the engine 1, a fuel consumption amount based on a measurement result of a fuel meter or the like, the method described in PTL 1, or the like.

### Regeneration Control Unit

The regeneration control unit 103 includes a regeneration state determination unit 1031 and a temperature rise control execution unit 1032. The regeneration state determination unit 1031 determines presence or absence of a regeneration request, and also determines whether the ash amount is equal to or less than a predetermined threshold value (assumed to be a threshold value M). For example, the regeneration request is set to “present” in a case in which the differential pressure of the DPF 52, which is measured by the differential pressure sensor 94, exceeds a predetermined threshold value, a case in which a predetermined time elapses from the previous regeneration, a case in which regeneration start is instructed by a manual operation of an operator, or other cases. The threshold value M is a value corresponding to the ash amount that allows the collection efficiency of the DPF 52 to be equal to or greater than a predetermined value due to ash accumulation even when 100% of the soot accumulated in the DPF 52 is removed by regeneration. Herein, the collection efficiency is the ratio of PM flowing out of the DPF 52 to PM flowing into the DPF 52, and is defined, for example, by a particulate number (PN). The ash amount accumulated in the DPF 52 is zero when the DPF 52 is new (or substantially zero after cleaning the DPF 52), and is increased as the engine 1 is operated. When the ash amount accumulated in the DPF 52 is equal to or less than a predetermined amount (for example, the threshold value M), a predetermined amount of soot is left after regeneration. With this, the collection efficiency can be equal to or greater than a predetermined value. In contrast, in a case in which the ash amount accumulated in the DPF 52 is greater than the predetermined amount (for example, the threshold value M), even when soot is not left after regeneration, (for example, the DPF 52 is regenerated while allowing a remaining amount of soot to be zero), the collection efficiency can be equal to or greater than the predetermined value.

When there is a regeneration request, the temperature rise control execution unit 1032 executes control for increasing the temperature of the exhaust gas at the time of regeneration of the exhaust purification device 300 (temperature rise control). During the temperature rise control, the temperature rise control execution unit 1032 sets a target temperature (referred to as a “DOC outlet regeneration target temperature TEMP0”) for the outlet temperature of the DOC 51, and controls the DOC outlet temperature to fall within a predetermined range with the DOC outlet regeneration target temperature TEMP0 as a reference (TEMP0 [° C.] to (TEMP0 [° C.]−TEMPa [° C.])). The set value TEMPa is a margin in the temperature control.

During the temperature rise control, first, the temperature rise control execution unit 1032 controls the valve opening degree of the exhaust throttle valve 71 to increase the temperature of the exhaust gas. When the inlet temperature measured by the inlet temperature sensor 92 is equal to or higher than the set temperature, fuel dosing by post-injection from the fuel injection device 11 of the engine 1 and injection from the fuel injection device 72 is started, for example. With this, the temperature of the exhaust gas is further increased. The set temperature at which fuel dosing is started is set based on a temperature (light-off temperature) at which the catalyst contained in the DOC 51 is activated. A fuel injected during fuel dosing is calculated based on a difference between the DOC inlet temperature and the DOC outlet regeneration target temperature or the like. The dosing fuel is supplied to the DOC 51 together with the exhaust gas, and generates heat through a chemical reaction with the oxidation catalyst in the DOC 51. Thus, the temperature of the exhaust gas is increased under control by the valve opening degree of the exhaust throttle valve 71, and is further increased while flowing through the DOC 51. Further, for example, when the cumulative time during which the DOC outlet temperature exceeds the pre-set temperature threshold value (TEMP0−TEMPa) reaches a pre-set time threshold value (referred to as a “time management regeneration time threshold value T0”), the temperature rise control execution unit 1032 terminates the temperature rise control, and sets the regeneration request to “absence”. In this case, the time management regeneration time threshold value T0 is a regeneration time of the DPF 52. Note that the time during which the DOC outlet temperature exceeds the temperature threshold value (TEMP0−TEMPa) may not be continuous for the duration of the time management regeneration time threshold value T0. For example, when a cumulative value within a predetermined time exceeds the time management regeneration time threshold value T0, it can be determined that regeneration is terminated.

In the present embodiment, the regeneration control unit 103 controls the regeneration of the DPF 52 so that the temperature rise control execution unit 1032 causes a predetermined amount of soot to remain in the DPF 52 when the regeneration state determination unit 1031 determines that the ash amount, which is estimated by the ash accumulation amount estimation unit 102, is equal to or less than the threshold value M, and controls the regeneration of the DPF 52 so that the remaining amount of soot in the DPF 52 is less than the predetermined value when the ash amount is greater than the threshold value M. In this state, in the first embodiment, the regeneration control unit 103 adjusts a remaining amount of soot in the DPF 52 by controlling the regeneration so that the outlet temperature of the DOC 51 (the regeneration temperature of the DPF 52) is lower than the temperature in a case in which the ash amount is greater than the threshold value M when the temperature rise control execution unit 1032 sets the ash amount to be equal to or less than the threshold value M and controlling the regeneration so that the outlet temperature of the DOC 51 is higher than the temperature in a case in which the ash amount is equal to or less than the threshold value M when the ash amount is greater than the threshold value M.

### Operation Example of First Embodiment

FIG. 3 illustrates an example of processing for single generation by the ECU 100 according to the first embodiment of the present disclosure. The processing illustrated in FIG. 3 is started when the regeneration request is present. When the processing illustrated in FIG. 3 is started, the temperature rise control execution unit 1032 starts the temperature rise control (step S11). Subsequently, the ash accumulation amount estimation unit 102 estimates an ash accumulation amount (hereinafter, also referred to as an “estimated ash accumulation amount”) (step S12). Subsequently, the regeneration state determination unit 1031 determines whether the estimated ash accumulation amount is greater than the threshold value M (step S13).

When the estimated ash accumulation amount is greater than the threshold value M (step S13: YES), the temperature rise control execution unit 1032 sets the DOC outlet regeneration target temperature TEMP0 to a set value TEMP1 (step S14). When the estimated ash accumulation amount is equal to or less than the threshold value M (step S13: NO), the temperature rise control execution unit 1032 sets the DOC outlet regeneration target temperature TEMP0 to a set value TEMP2 (step S15). Herein, the set value TMEP1 is a value of the DOC outlet regeneration target temperature TEMP0 when the ash amount accumulated in the DPF 52 is greater than the threshold value M, and may be a value corresponding to such a temperature that an amount of soot accumulated in the DPF 52 can be zero (or substantially zero), for example. The set value TMEP2 is a value of the DOC outlet regeneration target temperature TEMP0 when the ash amount accumulated in the DPF 52 is equal to or less than the threshold value M, is a value less than the set value TEMP1 (in other words, TEMP 2<TEMP 1), and is a value that allows a predetermined amount of soot to remain in the DPF 52 so that the collection efficiency is equal to or greater than a predetermined value. Note that the set values such as the set value TEMP1 and the set value TEMP2, and a set value T1 and a set value T2, which are described later, can be set based on simulation results obtained by using models of the engine system 10 and the DPF device 5, test results obtained by an actual machine, or the like, for example.

Subsequently, the temperature rise control execution unit 1032 determines whether the cumulative regeneration time satisfying “the DOC outlet regeneration target temperature TEMP0−TEMPa<the DOC outlet temperature” is greater than the time management regeneration time threshold value T0 (step S16). When the cumulative regeneration time is greater than the time management regeneration time threshold value T0 (step S16: YES), the temperature rise control execution unit 1032 sets the regeneration request to “absence”, terminates the regeneration (step S17), and terminates the processing illustrated in FIG. 3. When the cumulative regeneration time is equal to or less than the time management regeneration time threshold value T0 (step S16: NO), the temperature rise control execution unit 1032 returns to step S12, and re-executes the processing after step S12.

Note that, in the description given above, in the processing illustrated in FIG. 3, the processing from step S14 to step S17 is executed by the temperature rise control execution unit 1032. However, for example, the processing may be executed mainly by the regeneration state determination unit 1031. Further, when the result of the processing in step S16 is “NO”, the return destination may be step S16, for example.

FIG. 4 schematically illustrates an overview of internal resistance of the DPF 52, a regeneration state, and a temporal change of the regeneration temperature, where the horizontal axis represents a time (a total operation time of the engine 1) and the vertical axis represents the internal resistance of the DPF 52, the regeneration state, and the regeneration temperature. The internal resistance of the DPF 52 is expressed in terms of the differential pressure of the DPF 52 [kPa], the accumulation amount of PM [g] or [g/L], or the like. The solid line represents the (total) internal resistance of the DPF 52, the chain line represents the internal resistance of the DPF 52 due to accumulated ash, and the broken line represents the internal resistance of the DPF 52 due to accumulated ash corresponding to the threshold value M. When the internal resistance of the DPF 52 is represented in terms of the accumulation amount of PM [g] or [g/L], the solid line represents a total accumulation amount of PM (soot, ash, and the like), the chain line represents an ash accumulation amount, and the broken line represents an ash accumulation amount corresponding to the threshold value M. Note that internal resistance R1 is a margin from the internal resistance corresponding to the threshold value M. A point CP is a point at which the ash amount accumulated in the DPF 52 achieves a value corresponding to the threshold value M. The regeneration state indicates “presence” or “absence” of the regeneration request. The regeneration temperature is the outlet temperature of the DOC 51 [° C.].

A time ta1 is a time at which use of a new DPF 52 is started. In the example illustrated in FIG. 4, first generation is executed from a time ta2 to a time ta3, second generation is executed from a time ta4 to a time ta5, third generation is executed from a time ta7 to a time ta8, fourth generation is executed from a time ta9 to a time ta10, and fifth generation is executed from a time ta11 to a time ta12. Further, at a time ta6, the ash amount reaches the threshold value M. The DPF internal resistance represented by the solid line is gradually increased when generation is not executed, is gradually reduced when regeneration is started, and is gradually increased again when regeneration is terminated, as time elapses.

Before the ash amount reaches the threshold value M at the time ta6, the DOC outlet regeneration target temperature TEMP0−the set value TMEPa is controlled to be the set value TEMP2−the set value TEMPa. After the time ta6, the DOC outlet regeneration target temperature TEMP0−the set value TMEPa is controlled to be the set value TEMP1−the set value TEMPa. The time management regeneration time threshold value T0 is the same. In the example illustrated in FIG. 4, the set value TEMP2 is set so that the DPF internal resistance at the time of terminating the regeneration remains at a level equal to the total of the threshold value M and the internal resistance R1. Further, the set value TEMP1 is set so that soot accumulated in the DPF 52 can be removed to zero (or substantially zero) at the time of terminating the regeneration. In this case, before the time ta6, the internal resistance at the time of terminating the regeneration is adjusted to a value obtained by adding the internal resistance R1 to the threshold value M. After the time ta6, the internal resistance at the time of terminating the regeneration achieves a value corresponding to the internal resistance due to the ash accumulation amount.

### Actions and Effects of First Embodiment

In the first embodiment, the ECU 100 is a control device of the engine system 10 including the engine 1, the DOC 51 (oxidation catalyst) provided in the exhaust passage 3 of the engine 1, and the DPF 52 (filter) that collects soot within the exhaust passage 3, the soot being contained in the exhaust gas of the engine 1, and includes the ash accumulation amount estimation unit 102 that estimates the ash amount accumulated in the DPF 52, and the regeneration control unit 103 that controls the regeneration of the DPF 52 so that a predetermined amount of the soot remains in the DPF 52 when the ash amount is less than the predetermined threshold value M and controls the regeneration of the DPF 52 so that the remaining amount of soot in the DPF 52 is less than the predetermined value when the ash amount is greater than the threshold value M. With this configuration, when the ash amount accumulated in the DPF 52 is greater than the threshold value M, a soot amount remaining when the regeneration of the DPF 52 is terminated can be reduced easily.

Note that, in the first embodiment, the regeneration control unit 103 adjusts a remaining amount by controlling the regeneration when the ash amount is equal to or less than the threshold value M so that the outlet temperature of the DOC 51 is lower than when the ash amount is greater than the threshold value M and controlling the regeneration when the ash amount is greater than the threshold value M so that the outlet temperature of the DOC 51 is higher than when the ash amount is equal to or less than the threshold value M. With this configuration, the regeneration temperature of the DPF 52 is changed depending on whether the ash amount is equal to or less than the threshold value M. With this, a remaining amount of soot can be adjusted.

### Second Embodiment

Next, with reference to FIG. 5 and FIG. 6, a second embodiment of the present disclosure is described. The configurations of the engine system 10 and the ECU 100 according to the second embodiment are basically the same as the configurations in the first embodiment described with reference to FIG. 1 and FIG. 2. However, the first embodiment and the second embodiment are different from each other in certain aspects of the operation of the regeneration control unit 103 of the ECU 100. In the first embodiment, the regeneration temperature in the regeneration of the DPF 52 is changed depending on whether the ash amount is equal to or less than the threshold value M. In contrast, in the second embodiment, the regeneration time in the regeneration of the DPF 52 is changed depending on whether the ash amount is equal to or less than the threshold value M. The second embodiment is described below, mainly focusing on differences from the first embodiment.

In the present embodiment, similarly to the first embodiment, the regeneration control unit 103 controls the regeneration of the DPF 52 so that the temperature rise control execution unit 1032 causes a predetermined amount of soot to remain in the DPF 52 when the regeneration state determination unit 1031 determines that the ash amount, which is estimated by the ash accumulation amount estimation unit 102, is equal to or less than the threshold value M, and controls the regeneration of the DPF 52 so that the remaining amount of soot in the DPF 52 is less than the predetermined value when the ash amount is greater than the threshold value M. In this state, in the second embodiment, the regeneration control unit 103 adjusts a remaining amount of soot in the DPF 52 by controlling the regeneration so that the regeneration time of the DPF 52 is shorter than the time in a case in which the ash amount is greater than the threshold value M when the temperature rise control execution unit 1032 sets the ash amount to be equal to or less than the threshold value M and controlling the regeneration so that the regeneration time of the DPF 52 is longer than the time in a case in which the ash amount is equal to or less than the threshold value M when the ash amount is greater than the threshold value M.

### Operation Example of Second Embodiment

FIG. 5 illustrates an example of processing for single generation by the ECU 100 according to the second embodiment of the present disclosure. As compared to the flow illustrated in FIG. 3, in the flow illustrated in FIG. 5, the contents of step S14b illustrated in FIG. 5, which corresponds to step S14 illustrated in FIG. 3, and the contents of step S15b illustrated in FIG. 5, which corresponds to step S15 illustrated in FIG. 3, are different from those in the first embodiment. The other steps are the same in the first embodiment and the second embodiment.

In the processing illustrated in FIG. 5, when the estimated ash accumulation amount is greater than the threshold value M (step S13: YES), the temperature rise control execution unit 1032 sets the time management regeneration time threshold value T0 to the set value T1 (step S14b). When the estimated ash accumulation amount is equal to or less than the threshold value M (step S13: NO), the temperature rise control execution unit 1032 sets the time management regeneration time threshold value T0 to the set value T2 (step S15b). Herein, the set value T1 may be a value of the time management regeneration time threshold value T0 when the ash amount accumulated in the DPF 52 is greater than the threshold value M, and may be a value corresponding to such a regeneration time that an amount of soot accumulated in the DPF 52 can be zero (or substantially zero), for example. The set value T2 is a value of the time management regeneration time threshold value T0 when the ash amount accumulated in the DPF 52 is equal to or less than the threshold value M, is a value less than the set value T1 (in other words, T2<T1), and is a value that allows a predetermined amount of soot to remain in the DPF 52 so that the collection efficiency is equal to or greater than a predetermined value.

Similarly to FIG. 4, FIG. 6 schematically illustrates an overview of internal resistance of the DPF 52, a regeneration state, and a temporal change of the regeneration temperature. A time tb1 is a time at which use of a new DPF 52 is started. In the example illustrated in FIG. 6, first generation is executed from a time tb2 to a time tb3, second generation is executed from a time tb4 to a time tb5, third generation is executed from a time tb7 to a time tb8, fourth generation is executed from a time tb9 to a time tb10, and fifth generation is executed from a time tb11 to a time tb12. Further, at a time tb6, the ash amount reaches the threshold value M. The DPF internal resistance represented by the solid line is gradually increased when generation is not executed, is gradually reduced when regeneration is started, and is gradually increased again when regeneration is terminated, as time elapses.

Before the ash amount reaches the threshold value M at the time tb6, the regeneration time is controlled to be the set value T2. After the time tb6, the regeneration time is controlled to be the set value T1. The DOC outlet regeneration target temperature TEMP0 and the set value TEMPa are the same. In the example illustrated in FIG. 6, the set value T2 is set so that the DPF internal resistance at the time of terminating the regeneration remains at a level equal to the total of the threshold value M and the internal resistance R1. Further, the set value T1 is set so that soot accumulated in the DPF 52 can be removed to zero (or substantially zero) at the time of terminating the regeneration. In this case, before the time tb6, the internal resistance at the time of terminating the regeneration is adjusted to a value obtained by adding the internal resistance R1 to the threshold value M. After the time tb6, the internal resistance at the time of terminating the regeneration achieves a value corresponding to the internal resistance due to the ash accumulation amount.

### Actions and Effects of Second Embodiment

In the second embodiment, the ECU 100 is a control device of the engine system 10 including the engine 1, the DOC 51 (oxidation catalyst) provided in the exhaust passage 3 of the engine 1, and the DPF 52 (filter) that collects soot within the exhaust passage 3, the soot being contained in the exhaust gas of the engine 1, and includes the ash accumulation amount estimation unit 102 that estimates the ash amount accumulated in the DPF 52, and the regeneration control unit 103 that controls the regeneration of the DPF 52 so that a predetermined amount of the soot remains in the DPF 52 when the ash amount is less than the predetermined threshold value M and controls the regeneration of the DPF 52 so that the remaining amount of soot in the DPF 52 is less than the predetermined value when the ash amount is greater than the threshold value M. With this configuration, when the ash amount accumulated in the DPF 52 is greater than the threshold value M, a soot amount remaining when the regeneration of the DPF 52 is terminated can be reduced easily.

Note that, in the second embodiment, the regeneration control unit 103 adjusts a remaining amount by controlling the regeneration when the ash amount is equal to or less than the threshold value M so that the regeneration time of the DPF 52 is shorter than when the ash amount is greater than the threshold value M and controlling the regeneration when the ash amount is greater than the threshold value M so that the regeneration time of the DPF 52 is longer than when the ash amount is equal to or less than the threshold value M. With this configuration, the regeneration time of the DPF 52 is changed depending on whether the ash amount is equal to or less than the threshold value M. With this, a remaining amount of soot can be adjusted.

### Third Embodiment

Next, with reference to FIG. 7 and FIG. 8, a third embodiment of the present disclosure is described. The configurations of the engine system 10 and the ECU 100 according to the third embodiment are basically the same as the configurations in the first embodiment described with reference to FIG. 1 and FIG. 2. However, the first embodiment and the third embodiment are different from each other in certain aspects of the operation of the regeneration control unit 103 of the ECU 100. In the first embodiment, the regeneration temperature in the regeneration of the DPF 52 is changed depending on whether the ash amount is equal to or less than the threshold value M. In contrast, in the third embodiment, the regeneration temperature and the regeneration time in the regeneration of the DPF 52 are changed depending on whether the ash amount is equal to or less than the threshold value M. The third embodiment is described below, mainly focusing on differences from the first embodiment.

In the present embodiment, similarly to the first embodiment, the regeneration control unit 103 controls the regeneration of the DPF 52 so that the temperature rise control execution unit 1032 causes a predetermined amount of soot to remain in the DPF 52 when the regeneration state determination unit 1031 determines that the ash amount, which is estimated by the ash accumulation amount estimation unit 102, is equal to or less than the threshold value M, and controls the regeneration of the DPF 52 so that the remaining amount of soot in the DPF 52 is less than the predetermined value when the ash amount is greater than the threshold value M. In this state, in the third embodiment, the regeneration control unit 103 adjusts a remaining amount of soot in the DPF 52 by controlling the regeneration so that the regeneration temperature of the DPF 52 is lower than the temperature in a case in which the ash amount is greater than the threshold value M and the regeneration time of the DPF 52 is shorter than the time in a case in which the ash amount is greater than the threshold value M when the temperature rise control execution unit 1032 sets the ash amount to be equal to or less than the threshold value M and controlling the regeneration so that the regeneration temperature of the DPF 52 is higher than the temperature in a case in which the ash amount is greater than the threshold value M and the regeneration time of the DPF 52 is longer than the time in a case in which the ash amount is equal to or less than the threshold value M when the ash amount is greater than the threshold value M.

### Operation Example of Third Embodiment

FIG. 7 illustrates an example of processing for single generation by the ECU 100 according to the third embodiment of the present disclosure. As compared to the flow illustrated in FIG. 3, in the flow illustrated in FIG. 7, the contents of step S14c illustrated in FIG. 7, which corresponds to step S14 illustrated in FIG. 3, and the contents of step S15c illustrated in FIG. 7, which corresponds to step S15 illustrated in FIG. 3, are different from those in the first embodiment. The other steps are the same in the first embodiment and the third embodiment.

In the processing illustrated in FIG. 7, when the estimated ash accumulation amount is greater than the threshold value M (step S13: YES), the temperature rise control execution unit 1032 sets the DOC outlet regeneration target temperature TEMP0 to the set value TEMP1, and sets the time management regeneration time threshold value T0 to the set value T1 (step S14c. When the estimated ash accumulation amount is equal to or less than the threshold value M (step S13: NO), the temperature rise control execution unit 1032 sets the DOC outlet regeneration target temperature TEMP0 to the set value TEMP2, and sets the time management regeneration time threshold value T0 to the set value T2 (step S15b). Herein, the set value TEMP1 and the set value T1 are a value of the DOC outlet regeneration target temperature TEMP0 and a value of the time management regeneration time threshold value T0 when the ash amount accumulated in the DPF 52 is greater than the threshold value M. For example, when the DOC outlet regeneration target temperature TEMP0 is the set value TEMP1, and the time management regeneration time threshold value T0 is the set value T1, the set value TEMP1 and the set value T1 may be values corresponding to such a combination of a regeneration temperature and a regeneration time that an amount of soot accumulated in the DPF 52 can be zero (or substantially zero). The set value TEMP2 and the set value T2 are a value of the DOC outlet regeneration target temperature TEMP0 and a value of the time management regeneration time threshold value T0 when the ash amount accumulated in the DPF 52 is equal to or less than the threshold value M, are a value less than the set value TEMP1 and a value less than the set value T1, respectively, (in other words, TEMP 2<TEMP 1 and T2<T1), and are a combination of values that allows a predetermined amount of soot to remain in the DPF 52 so that the collection efficiency is equal to or greater than a predetermined value.

Similarly to FIG. 4, FIG. 8 schematically illustrates an overview of internal resistance of the DPF 52, a regeneration state, and a temporal change of the regeneration temperature. A time tc1 is a time at which use of a new DPF 52 is started. In the example illustrated in FIG. 8, first generation is executed from a time tc2 to a time tc3, second generation is executed from a time tc4 to a time tc5, third generation is executed from a time tc7 to a time tc8, fourth generation is executed from a time tc9 to a time tc10, and fifth generation is executed from a time tc11 to a time tc12. Further, at a time tc6, the ash amount reaches the threshold value M. The DPF internal resistance represented by the solid line is gradually increased when generation is not executed, is gradually reduced when regeneration is started, and is gradually increased again when regeneration is terminated, as time elapses.

Before the ash amount reaches the threshold value M at the time tc6, the DOC outlet regeneration target temperature TEMP0−the set value TMEPa is controlled to be the set value TEMP2−the set value TEMPa, and the regeneration time is controlled to be the set value T2. After the time tc6, the DOC outlet regeneration target temperature TEMP0−the set value TMEPa is controlled to be the set value TEMP1−the set value TEMPa, and the regeneration time is controlled to be the set value T1. The DOC outlet regeneration target temperature TEMP0 and the set value TEMPa are the same. In the example illustrated in FIG. 8, the set value TEMP2 and the set value T2 are set so that the DPF internal resistance at the time of terminating the regeneration remains at a level equal to the total of the threshold value M and the internal resistance R1. Further, the set value TEMP1 and the set value T1 are set so that soot accumulated in the DPF 52 can be removed to zero (or substantially zero) at the time of terminating the regeneration. In this case, before the time tc6, the internal resistance at the time of terminating the regeneration is adjusted to a value obtained by adding the internal resistance R1 to the threshold value M. After the time tc6, the internal resistance at the time of terminating the regeneration achieves a value corresponding to the internal resistance due to the ash accumulation amount.

### Actions and Effects of Third Embodiment

In the third embodiment, the ECU 100 is a control device of the engine system 10 including the engine 1, the DOC 51 (oxidation catalyst) provided in the exhaust passage 3 of the engine 1, and the DPF 52 (filter) that collects soot within the exhaust passage 3, the soot being contained in the exhaust gas of the engine 1, and includes the ash accumulation amount estimation unit 102 that estimates the ash amount accumulated in the DPF 52, and the regeneration control unit 103 that controls the regeneration of the DPF 52 so that a predetermined amount of the soot remains in the DPF 52 when the ash amount is less than the predetermined threshold value M and controls the regeneration of the DPF 52 so that the remaining amount of soot in the DPF 52 is less than the predetermined value when the ash amount is greater than the threshold value M. With this configuration, when the ash amount accumulated in the DPF 52 is greater than the threshold value M, a soot amount remaining when the regeneration of the DPF 52 is terminated can be reduced easily.

Note that, in the third embodiment, the regeneration control unit 103 can adjust a remaining amount of soot by controlling the regeneration when the ash amount is equal to or less than the threshold value M so that the outlet temperature of the DOC 51 is lower and the regeneration time of the DPF 52 is shorter than when the ash amount is greater than the threshold value M and controlling the regeneration when the ash amount is greater than the threshold value M so that the outlet temperature of the DOC 51 is higher and the regeneration time of the DPF 52 is longer than when the ash amount is equal to or less than the threshold value M.

### Actions and Effects of Present Disclosure

According to the present disclosure, when the ash amount is greater than the predetermined threshold value M, the regeneration of the DPF 52 is controlled so that the remaining amount of soot in the DPF 52 is less than the predetermined amount. Thus, when the ash amount is greater than the predetermined threshold value M, the soot amount remaining when the regeneration of the DPF 52 is terminated can be reduced easily.

### Modification Examples and the Like

The embodiments of the present disclosure are described above with reference to the drawings. However, the specific configurations are not limited to the above-mentioned embodiments, and includes design modifications and the like that do not depart from the gist of the present disclosure. For example, the device that increases the temperature of the exhaust gas may be a burner, a variable turbocharger, or the like. Note that, for comparisons with the threshold values and the like, “equal to or less than” may be interpreted as “less than”, and “greater than” may be interpreted as “equal to or greater than”. Further, a part or an entirety of the program executed by the computer in the above-mentioned embodiments can be distributed via a computer-readable recording medium or a communication line.

### Supplementary Notes

The control device (ECU 100) of the embodiments can be understood as follows.

(1) The control device (ECU 100) according to a first aspect of the present disclosure is the control device of the engine system 10 including the engine 1, the oxidation catalyst (DOC 51) provided in the exhaust passage 3 of the engine 1, and the filter (DPF 52) configured to collect soot within the exhaust passage 3, the soot contained in exhaust gas of the engine 1, the control device including: the ash accumulation amount estimation unit 102 configured to estimate an ash amount accumulated in the filter; and the regeneration control unit 103 configured to control regeneration of the filter when the ash amount is equal to or less than a predetermined threshold value so that a predetermined amount of the soot remains in the filter, and control regeneration of the filter when the ash amount is greater than the threshold value so that the remaining amount of the soot in the filter is less than the predetermined amount. According to this aspect and each of the following aspects, an amount of soot remaining when regeneration is terminated can be reduced.

(2) A control device according to a second aspect of the present disclosure is the control device according to (1) wherein the regeneration control unit adjusts the remaining amount by controlling the regeneration when the ash amount is equal to or less than the threshold value so that an outlet temperature of the oxidation catalyst is lower than when the ash amount is greater than the threshold value and controlling the regeneration when the ash amount is greater than the threshold value so that the outlet temperature of the oxidation catalyst is higher than when the ash amount is equal to or less than the threshold value.

(3) A control device according to a third aspect of the present disclosure is the control device according to (1), wherein the regeneration control unit adjusts the remaining amount by controlling the regeneration when the ash amount is equal to or less than the threshold value so that a regeneration time of the filter is shorter than when the ash amount is greater than the threshold value and controlling the regeneration when the ash amount is greater than the threshold value so that the regeneration time of the filter is longer than when the ash amount is equal to or less than the threshold value.

(4) A control device according to a fourth aspect of the present disclosure is the control device according to (1), wherein the regeneration control unit adjusts the remaining amount by controlling the regeneration when the ash amount is equal to or less than the threshold value so that an outlet temperature of the oxidation catalyst is lower and a regeneration time of the filter is shorter than when the ash amount is greater than the threshold value and controlling the regeneration when the ash amount is greater than the threshold value so that the outlet temperature of the oxidation catalyst is higher and the regeneration time of the filter is longer than when the ash amount is equal to or less than the threshold value.

(5) A control device according to a fifth aspect of the present disclosure is the control device according to any one of (1) to (4), wherein the ash accumulation amount estimation unit estimates the ash amount, based on a fuel injection amount. According to this aspect, the ash amount can be estimated based on a fuel injection amount.

### Industrial Applicability

According to the aspect described above, an amount of soot remaining when regeneration is terminated can be reduced.

### REFERENCE SIGNS LIST

10 Engine system, 100 ECU, 101 Information acquisition unit, 102 Ash accumulation amount estimation unit, 103 Regeneration control unit, 1031 Regeneration state determination unit, 1032 Temperature rise control execution unit, 1 Engine, 2 Turbocharger, 11, 72 Fuel injection device, 300 Exhaust purification device, 3 Exhaust passage, 71 Exhaust throttle valve, 5 DPF device, 51 DOC, 52 DPF, 73 Urea water injection device, 6 SCR device, 91 Engine speed sensor, 92 Inlet temperature sensor, 93 Outlet temperature sensor, 94 Differential pressure sensor

1. A control device of an engine system including an engine, an oxidation catalyst provided in an exhaust passage of the engine, and a filter configured to collect soot within the exhaust passage, the soot being contained in exhaust gas of the engine, the control device comprising:
an ash accumulation amount estimation unit configured to estimate an ash amount accumulated in the filter; and
a regeneration control unit configured to control regeneration of the filter when the ash amount is equal to or less than a predetermined threshold value so that a predetermined amount of the soot remains in the filter, and control regeneration of the filter when the ash amount is greater than the threshold value so that the remaining amount of the soot in the filter is less than the predetermined amount.

2. The control device according to claim 1, wherein
the regeneration control unit adjusts the remaining amount by controlling the regeneration when the ash amount is equal to or less than the threshold value so that an outlet temperature of the oxidation catalyst is lower than when the ash amount is greater than the threshold value and controlling the regeneration when the ash amount is greater than the threshold value so that the outlet temperature of the oxidation catalyst is higher than when the ash amount is equal to or less than the threshold value.

3. The control device according to claim 1, wherein
the regeneration control unit adjusts the remaining amount by controlling the regeneration when the ash amount is equal to or less than the threshold value so that a regeneration time of the filter is shorter than when the ash amount is greater than the threshold value and controlling the regeneration when the ash amount is greater than the threshold value so that the regeneration time of the filter is longer than when the ash amount is equal to or less than the threshold value.

4. The control device according to claim 1, wherein
the regeneration control unit adjusts the remaining amount by controlling the regeneration when the ash amount is equal to or less than the threshold value so that an outlet temperature of the oxidation catalyst is lower and a regeneration time of the filter is shorter than when the ash amount is greater than the threshold value and controlling the regeneration when the ash amount is greater than the threshold value so that the outlet temperature of the oxidation catalyst is higher and the regeneration time of the filter is longer than when the ash amount is equal to or less than the threshold value.

5. The control device according to claim 1 4, wherein
the ash accumulation amount estimation unit estimates the ash amount, based on a fuel injection amount.

6. A control method of an engine system including an engine, an oxidation catalyst provided in an exhaust passage of the engine, and a filter configured to collect soot within the exhaust passage, the soot being contained in exhaust gas of the engine, the control method comprising:
a estimating an ash amount accumulated in the filter; and
a controlling regeneration of the filter when the ash amount is equal to or less than a predetermined threshold value so that a predetermined amount of the soot remains in the filter and controlling regeneration of the filter when the ash amount is greater than the threshold value so that the remaining amount of the soot in the filter is less than the predetermined amount.

7. An engine system comprising:
an engine;
an oxidation catalyst provided in an exhaust passage of the engine;
a filter configured to collect soot within the exhaust passage, the soot being contained in exhaust gas of the engine; and
a control device configured to control regeneration of the filter, wherein
the control device includes:
an ash accumulation amount estimation unit configured to estimate an ash amount accumulated in the filter; and
a regeneration control unit configured to control regeneration of the filter when the ash amount is equal to or less than a predetermined threshold value so that a predetermined amount of the soot remains in the filter, and control regeneration of the filter when the ash amount is greater than the threshold value so that the remaining amount of the soot in the filter is less than the predetermined amount.

8. The control device according to claim 2, wherein
the ash accumulation amount estimation unit estimates the ash amount, based on a fuel injection amount.

9. The control device according to claim 3, wherein
the ash accumulation amount estimation unit estimates the ash amount, based on a fuel injection amount.

10. The control device according to claim 4, wherein
the ash accumulation amount estimation unit estimates the ash amount, based on a fuel injection amount.
